(19) United States
(12) Patent Application Publication
(10) Pub. No.: US 2025/0249836 A1
(43) Pub. Date: Aug. 7, 2025

(54) ROOF RACK SUB-ASSEMBLY FOR A MOTOR VEHICLE

(71) Applicant: Ford Global Technologies, LLC, Dearborn, MI (US)

(72) Inventors: Thomas Benderoth, Gummersbach (DE); Jan Eschweiler, Cologne (DE); Martin Tamayo Korte, Bottrop (DE); Morten Pyroth, Leverkusen (DE)

(73) Assignee: Ford Global Technologies, LLC, Dearborn, MI (US)

(21) Appl. No.: 19/011,708

(22) Filed: Jan. 7, 2025

(30) Foreign Application Priority Data
Feb. 1, 2024 (DE) 102024102829.7

(51) Int. Cl. B60R 9/058

(52) U.S. Cl. CPC B60R 9/058

(57) ABSTRACT

A roof rack sub-assembly for a motor vehicle has a roof element, a body side component, a support foot for supporting a roof cross-beam which extends above the roof element in an assembly state of the roof rack sub-assembly and an anchor element for at least indirectly connecting the support foot to the body side component. In order to optimize the assembly of a roof rack in a vehicle with a glass roof, the body side component has a lock portion having a lock opening, wherein the anchor element can be guided with a key portion through the lock opening along a closure axis into an introduction position and can be rotated out of the introduction position about the closure axis into a locking position in which the key portion engages with the lock portion in the direction of the closure axis in a positive-locking manner.

### CROSS-REFERENCE TO RELATED APPLICATION

This application claims foreign priority benefits under 35 U.S.C. § 119 (a)-(d) to German Application No. 102024102829.7 filed Feb. 1, 2024, which is hereby incorporated by reference in its entirety.

### FIELD OF THE DISCLOSURE

The present disclosure generally relates to vehicle roof racks, and more particularly relates to a roof rack sub-assembly for a motor vehicle.

### BACKGROUND OF THE DISCLOSURE

In modern passenger motor vehicles, in addition to roofs which are coated with sheet metal or plastics material, glass roofs are also used. Such a glass roof generally may extend in the longitudinal direction over a significant portion of the passenger compartment. In a transverse direction, the glass roof typically extends laterally up to a location adjacent to body side components into the region of the vehicle pillars. In order not to impair incoming light and viewing sight, the glass roof may include one or more glass elements which are configured to be self-supporting as opposed to using metal reinforcement elements. With such vehicles having a glass roof there is also often a desire to be able to fit a roof rack. In order to secure the roof rack, either a roof rail may be used or screws with internal threads may be used in the door opening or roof region, however, that may reduce the appearance and the aerodynamics of the vehicle.

It is desirable to provide for a roof rack assembly that optimizes the assembly of a roof rack in a vehicle, particularly with a glass roof.

### SUMMARY OF THE DISCLOSURE

According to a first aspect of the present disclosure, a roof rack sub-assembly for a motor vehicle has a roof element, a body side component having a lock portion having a lock opening, a support foot for supporting a roof cross-beam which extends above the roof element in an assembly state of the roof rack sub-assembly, and an anchor element for at least indirectly connecting the support foot to the body side component. The anchor element is configured to be guided with a key portion through the lock opening along a closure axis into an introduction position and is further configured to be rotated out of the introduction position about the closure axis into a locking position in which the key portion engages with the lock portion in a direction of the closure axis in a positive-locking manner.

Embodiments of the first aspect of the present disclosure can include any one or a combination of the following features:
the roof element is a glass roof element;
the glass roof element is connected to the body side component by an adhesive connection;
the body side component has a trim element having a surface portion which forms an outer face of the motor vehicle, and the lock portion is formed by a lock element which is at least indirectly secured to the trim element;
the surface portion is separated from the roof element by a gap region in which the lock portion is at least partially arranged;
the lock portion is arranged in a state recessed with respect to the surface portion and the roof element;
the body side component is horizontally adjacent to the roof element;
the roof element is connected to the body side component by an adhesive connection;
the anchor element has a shaft portion which extends along the closure axis and which in the assembly state is received at least partially in a positive-locking manner in the support foot;
the key portion has a central portion which is arranged around the closure axis and at least one wing portion which protrudes radially from the central portion;
the lock portion has at least one tangentially limited stop portion which is configured, by a tangential positive-locking connection to the key portion, to limit the rotatability of the anchor element about the closure axis;
the support foot is supported in the assembly state on the surface portion and is spaced apart from the roof element; and
a clamping element is configured in the assembly state to engage in a positive-locking manner with the anchor element and the support foot and to pretension the support foot with respect to the surface portion.

According to a second aspect of the present disclosure, a roof rack sub-assembly for a motor vehicle has a glass roof element and a body side component horizontally adjacent to the glass roof element and having a lock portion having a lock opening. The body side component has a trim element having a surface portion which forms an outer face of the motor vehicle, and the lock portion is formed by a lock element which is at least indirectly secured to the trim element. The roof rack sub-assembly may also include a support foot for supporting a roof cross-beam which extends above the roof element in an assembly state of the roof rack sub-assembly and an anchor element for at least indirectly connecting the support foot to the body side component. The anchor element is configured to be guided with a key portion through the lock opening along a closure axis into an introduction position and is further configured to be rotated out of the introduction position about the closure axis into a locking position in which the key portion engages with the lock portion in a direction of the closure axis in a positive-locking manner.

Embodiments of the second aspect of the present disclosure can include any one or a combination of the following features:
the surface portion is separated from the roof element by a gap region in which the lock portion is at least partially arranged;
the lock portion is arranged in a state recessed with respect to the surface portion and the glass roof element;
the glass roof element is connected to the body side component by an adhesive connection;
the anchor element has a shaft portion which extends along the closure axis and which in the assembly state is received at least partially in a positive-locking manner in the support foot;
the key portion has a central portion which is arranged around the closure axis and at least one wing portion which protrudes radially from the central portion, and wherein the lock portion has at least one tangentially limited stop portion which is configured, by a tangential positive-locking connection to the key portion, to limit the rotatability of the anchor element about the closure axis; and
a clamping element is configured in the assembly state to engage in a positive-locking manner with the anchor element and the support foot and to pretension the support foot with respect to the surface portion.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective illustration of a roof rack sub-assembly according to an exemplary embodiment;

FIG. 2 is a first cross-sectioned illustration of the roof rack sub-assembly taken from FIG. 1;

FIG. 3 is a second cross-sectioned illustration of the roof rack sub-assembly taken shown in FIG. 1;

FIG. 4 is a perspective illustration of elements of the roof rack sub-assembly from FIG. 1 with an anchor element in a decoupled position;

FIG. 5 is a perspective illustration according to FIG. 4 with the anchor element in an introduction position; and

FIG. 6 is a perspective illustration according to FIG. 4 with the anchor element in a locking position.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

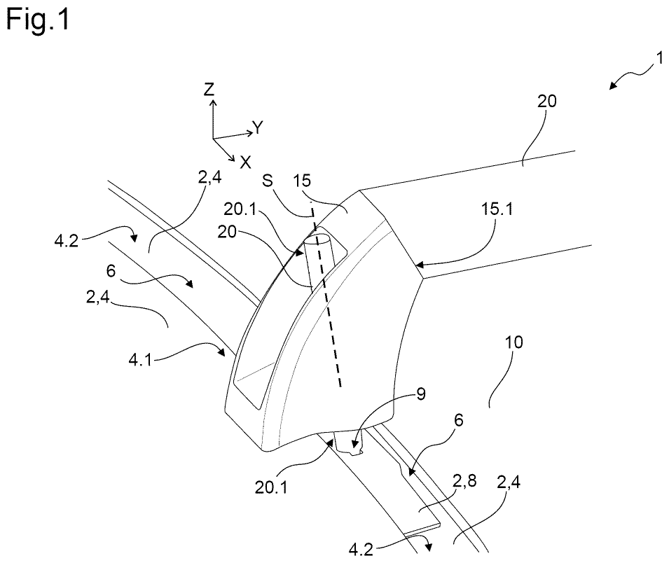

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an insert unit for insertion into a storage compartment of a center console of a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The present application may refer to amounts and numbers. Unless expressly stated otherwise, such amounts and numbers should not be considered limiting but should be considered examples of the possible amounts or numbers in the context of the present application. In this context, the present application might also use the phrase “a plurality of” in order to refer to an amount or number. In this context, the phrase “a plurality of” should be in any number greater than one, e.g., two, three, four, five, etc. The terms “around”, “approximately”, “near”, etc. mean plus or minus 5% of the value specified.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

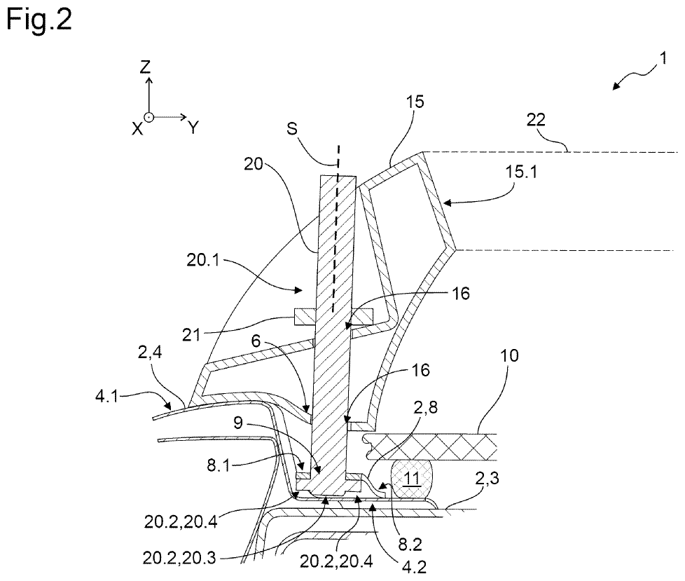

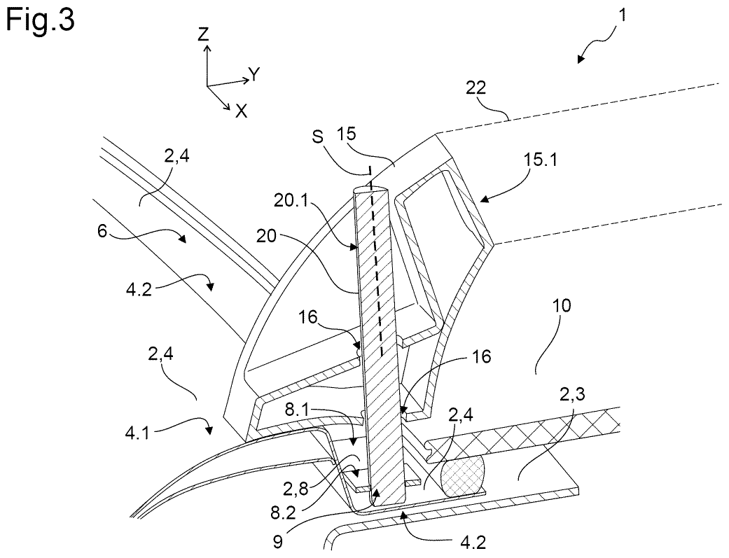

FIG. 1 shows a perspective illustration of a roof rack sub-assembly 1 according to one embodiment for a motor vehicle, for example, for a passenger vehicle. FIGS. 2 and 3 show sectioned illustrations of the roof rack sub-assembly 1 shown in FIG. 1. In the figures, a longitudinal axis X, a transverse axis Y and a vertical axis Z are in each case depicted. FIGS. 1-3 show in each case an assembly state in which the roof rack sub-assembly 1 is correctly mounted and ready for use. The roof rack sub-assembly 1 has a roof element 10 which may, for example, be in the form of a glass roof element, according to one embodiment. With regard to the transverse axis Y adjacent to the roof element 10, a body side component 2 which like the roof element 10 is part of a body of the motor vehicle is illustrated. It has a structural element 3 which is formed from sheet steel and a trim element 4 which is supported thereon and which may be formed from thinner sheet steel, plastics material or fiber composite material. The trim element 4 is supported by the structural element 3 and can be welded, adhesively bonded or connected thereto in another manner. The trim element 4 has a surface portion 4.1 which forms an outer face of the motor vehicle. The trim element 4 may be painted in known manner in order to produce an appealing appearance. The trim element 4 is adjoined by a recessed portion 4.2 which extends downward with respect with the vertical axis Z and which extends further with respect to the transverse axis Y in the direction of the roof element 10 and partially below it. The roof element 10 is connected to the recessed portion 4.2 of the trim element 4 by means of an adhesive connection 11. The surface portion 4.1 is separated from the roof element 10 by a gap region 6 which is partially delimited by the recessed portion 4.2.

A lock element 8 made of sheet steel is arranged in the gap region 6 mentioned so that the lock element 8 is arranged in a state recessed with respect to the surface portion 4.1 and the roof element 10. The lock element 8 is connected to the recessed portion 4.2 by two connection portions 8.1. The connection may be produced in a manner which is not illustrated here by adhesive bonding, welding, screwing or the like. Furthermore, between the connection portions 8.1 a lock portion 8.2 having a lock opening 9 which extends along a substantially vertical closure axis S through the lock portion 8.2 is formed.

A support foot 15 of the roof rack sub-assembly 1 serves to support a roof cross-beam 22 which is illustrated only partially and schematically in the figures. The support foot 15 extends parallel with the transverse axis Y above the roof element 10 and is connected to a connection region 15.1 of the support foot 15. An anchor element 20 is guided with a cylindrical shaft portion 20.1 which extends parallel with the closure axis S through two through-openings 16 of the support foot 15. By use of a clamping element 21, a positive-locking connection with respect to the closure axis S is produced between the anchor element 20 and the support foot 15. The clamping element 21 is illustrated only schematically in FIG. 2 and may, for example, be in the form of a nut which cooperates with an outer thread of the shaft portion 20.1. At a lower end of the anchor element 20 there is formed a key portion 20.2 which is guided through the lock opening 9. It engages behind the lock portion 8.2 with two wing portions 20.4 which extend radially outward from a central portion 20.3. On the whole, the support foot 15 is connected to the body side component 2 via the anchor element 20. In this instance, the support foot 15 is pretensioned by the clamping element 21 and the anchor element 20 with respect to the surface portion 4.1.

As can be seen in FIG. 2, the support foot 15 is supported in the assembly state on the surface portion 4.1, but is spaced apart from the roof element 10. The latter is consequently not loaded by the support foot 15 or a load resting on the roof cross-beam 22. Furthermore, there remains for the roof element 10 along the transverse axis Y in the direction of the trim element 4 a movement play which, for example, may be necessary in the case of a thermal expansion.

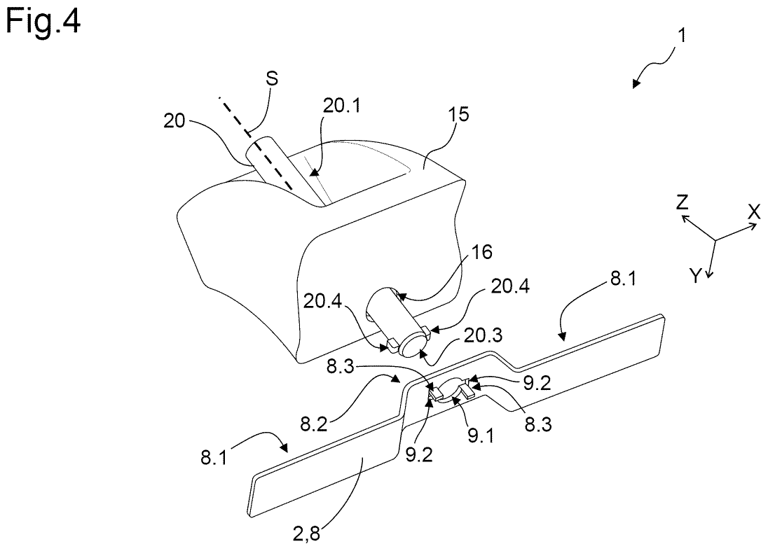

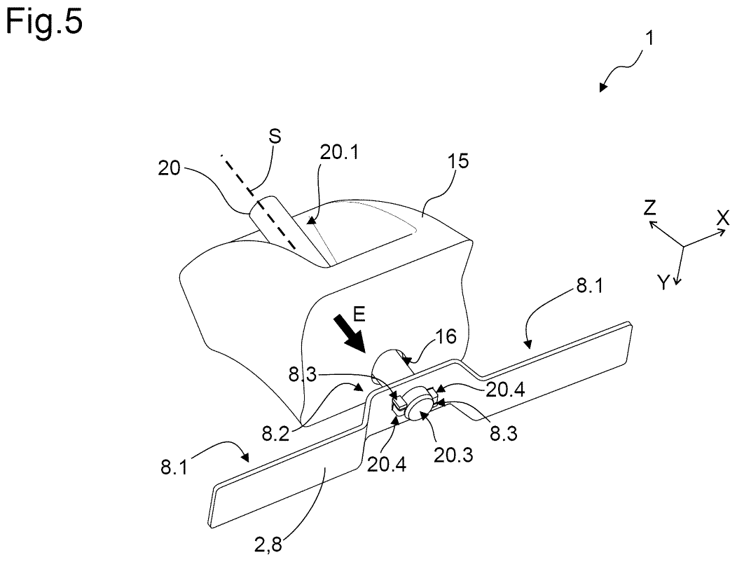

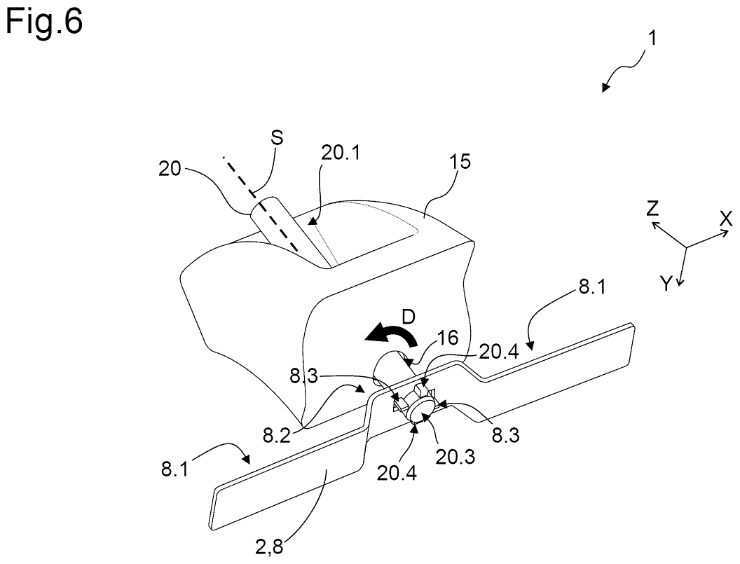

The assembly of the anchor element 20 and the support foot 15 will now be described with reference to FIGS. 4-6. In order to make the relevant regions more clearly visible, in these figures the structural element 3, the trim element 4 and the roof element 10 are omitted. FIG. 4 shows the anchor element 20 which is guided through the through-openings 16 in a decoupled position, in which the shaft portion 20.1 and the key portion 20.2 are located outside the lock opening 9. The lock opening 9 has a circular-cylindrical inner portion 9.1 and two radially outwardly protruding outer portions 9.2. The shape and size of the inner portion 9.1 are adapted to the main portion 20.3 of the key portion 20.2, while the shape and size of the outer portions 9.2 are adapted to the wing portions 20.4. Therefore, the key portion 20.2 can be guided by a translational introduction movement E parallel with the closure axis S through the lock opening 9 into an introduction position which is illustrated in FIG. 5. In this introduction position, each wing portion 20.4 rests in a tangential direction on a stop portion 8.3 which extends adjacent to an outer portion 9.2 in a downward direction. Starting from the introduction position, the anchor element 20 by usage of a rotational movement D about the closure axis S can be rotated into a locking position which is illustrated in FIG. 6. In this locking position, the wing portions 20.4 engage in a positive-locking manner with the lock portion 8.2 so that the anchor element 20 cannot be removed along the closure axis S from the introduction opening 9. In this state, the clamping element 21 can be used in order to pretension the support foot 15 with respect to the trim element 4.

In FIGS. 5 and 6, the introduction position and locking position differ as a result of a rotational movement D though approximately 90°. Of course, the rotational movement could also be carried out through a smaller or larger angle. However, the stop portions 8.3 prevent a rotation through 180° since there is previously a tangential positive-locking connection with the wing portions 20.4. When the anchor element 20 is disassembled, the rotational movement D is reversed, wherein the stop portions 8.3, as a result of a positive-locking connection with the wing portions 20.4, prevent the anchor element 20 from being rotated beyond the introduction position. Afterwards, the anchor element 20 can be decoupled by reversing the introduction movement E.

According to the disclosure, a roof rack sub-assembly for a motor vehicle is provided. In this instance, the term “motor vehicle” relates in a narrower sense to a road vehicle, that is to say, a vehicle which is suitable and permitted for road traffic, which is naturally intended to be limiting and is intended to include off-road vehicles. In particular, it may be a passenger vehicle, a lorry or a bus, for example. With regard to the driving of the motor vehicle, there are no limitations, it may, for example, be driven by an internal combustion engine which uses as fuel petrol, diesel, LPG, hydrogen or another gas. Alternatively or additionally, an electric motor which, for example, may be supplied with energy by means of a battery unit and/or a fuel cell may be provided. Preferably, the motor vehicle has at least two axles with two wheels in each case, but variations from this are also conceivable.

The term “roof rack sub-assembly” relates to the fact that it has at least one part of a roof rack, and at least one component on which the roof rack is arranged. On the whole, the sub-assembly is arranged in the region of a vehicle roof which closes off an interior of the motor vehicle, typically a passenger compartment, in an upward direction.

The roof rack sub-assembly has a roof element. The roof element forms at least a portion of the vehicle roof and extends along the longitudinal vehicle axis (X-axis) and along the transverse vehicle axis (Y axis) However, it does not necessarily extend parallel with one of these axes. On the whole, it is configured in a planar manner. It may comprise one or more layers. The roof element is provided to terminate the above-mentioned interior in an upward direction and in particular to protect it from weather influences. Accordingly, the roof element is typically configured per se in a water-tight manner. It is preferably configured per se in a rigid manner, but which does not exclude, for example, a limited resilient deformability.

Furthermore, the roof rack sub-assembly has a body side component which is horizontally adjacent to the roof element. The body side component belongs like the roof element to the body of the motor vehicle. It is arranged adjacent in a horizontal direction to the roof element, in particular it may with respect to the transverse vehicle axis be adjacent to the roof element. The horizontal position of the body side component may partially intersect with that of the vehicle roof, for example, in such a manner that an edge region of the body side component is arranged below the vehicle roof. The body side component can be directly connected to the roof element. It may belong to a lateral component of the body with respect to the transverse vehicle axis. It may be configured in an integral manner. In other embodiments, it has a plurality of elements which are connected to each other.

Furthermore, a support foot for supporting a roof cross-beam which extends above the roof element is provided in an assembly state of the roof rack sub-assembly. The roof cross-beam is provided to support at least proportionately a load which is intended to be transported on the vehicle roof. It extends in the assembly state, which can also be referred to as the assembled state or fitted state, along the transverse vehicle axis. The roof cross-beam may be considered to be part of the roof rack sub-assembly. It extends with respect to the vertical vehicle axis (Z axis) above the roof element and can completely bridge the roof element. The support foot is provided to support the roof cross-beam. The support foot may in this instance be connected to an end portion of the roof cross-beam or be permanently connected. Another support foot may be associated with the opposing end portion of the roof cross-beam so that the individual support foot supports only a portion of the weight of the roof cross-beam and the load. In order to ensure the necessary stability, the support foot may be made at least partially from metal.

According to the disclosure, the body side component has a lock portion having a lock opening. The lock portion is part of the body side component. It may be produced from metal, for example, from sheet steel, but other materials such as plastics material or composite fiber material are also possible. At least the lock portion is advantageously configured per se in a rigid manner, which may preferably also apply to the body side component in its entirety. The lock portion has the lock opening which may, in particular, be in the form of a through-opening. The term “lock opening” serves primarily to characterize the function further described below and is otherwise not intended to be interpreted to be limiting.

Furthermore, according to the disclosure, the roof rack sub-assembly has an anchor element for at least indirectly connecting the support foot to the body side component, which anchor element can be or is guided with a key portion through the lock opening along a closure axis into an introduction position and can be or is rotated from the introduction position about the closure axis into a locking position, in which the key portion engages in a positive-locking manner with the lock portion in the direction of the closure axis. The anchor element may in the assembly state be connected directly or indirectly to the support foot. On the whole, it is at least indirectly, that is to say where applicable via an additional element, arranged between the support foot and the body side component. In particular, it may be configured to transmit forces between these members. It has a key portion. This may in particular be formed at the end of the anchor element. By the anchor element being guided in translation along the closure axis, the key portion can be guided through the lock opening. The term “along the closure axis” preferably means parallel with the closure axis, but an angle may also be located between the movement direction of the anchor element and the closure axis. However, in some examples, this angle is preferably a maximum of 45°, more preferably a maximum of 30° or even more preferably a maximum of 10°. The cross section of the key portion and the cross section of the lock opening may preferably be adapted to each other. That is to say, they may almost correspond with the exception of a gap dimension which is necessary for undisrupted passage of the key portion. Starting from the introduction position, the anchor element may be rotated about the closure axis into the locking position. In this position, the key portion and the lock portion engage with each other in a positive-locking manner in the direction of the closure axis. As a result of the corresponding positive-locking connection, the anchor element can no longer be pulled back in translation along the closure axis. It could be said that the key portion in the locking position engages behind the lock portion. It may be realized that in order to achieve the positive-locking connection, the lock opening and the key portion partially have a non-circular cross section which is centered with respect to the closure axis. Otherwise a rotation about the closure axis would not lead to a locking. On the whole, the translational guiding of the anchor element into the introduction position corresponds to the insertion of a key in a lock, while the rotation about the closure axis corresponds to the rotation of the key. Of course, the anchor element by use of the reverse movement sequence can be decoupled from the lock portion again and consequently from the body side component.

The roof rack sub-assembly enables an arrangement of a roof rack on a vehicle roof, which can be produced in particular without incorporating the roof element. Consequently, for example, a mechanical impairment of the roof element is also dispensed with. Furthermore, the connection can be produced in a space-saving manner, as will be further explained below. The connection is based partially on a positive-locking connection between the anchor element and lock portion and can consequently be released again as necessary. Furthermore, it is advantageous with regard to the intended cooperation of the anchor element with the lock portion that the movement sequence for locking and unlocking the anchor element requires only a small amount of space. After the translational introduction along the closure axis, there is a rotation about the closure axis, that is to say, any tilting movements about other axes or translational movements perpendicular to the closure axis are unnecessary. The intended closure movement also enables a space-saving configuration of the lock portion and the key portion.

The roof element may, for example, be made from sheet metal, plastics material or composite material. A combination of these materials is also conceivable. In particular, the roof element may be in the form of a glass roof element. That is to say, the glass roof element comprises at least primarily glass, wherein this term in addition to glasses in the chemical/physical sense also covers other light-permeable materials. Of course the glass roof element may also be tinted in order to limit the light transmission. Furthermore, the glass element may be produced from a plurality of layers, for example, at least one glass layer and at least one plastics material layer. It may also have a surface coating, for example, a partial mirroring. Furthermore, the roof element, particularly when it is in the form of a glass roof element, may preferably be connected to the body side component by an adhesive connection. In particular with a glass roof element, for example, a connection by screwing, riveting or welding is not preferred in some scenarios. In this instance, therefore, an adhesive connection represents an advantageous connection possibility. The adhesive can be applied at the edge of the roof element in elongate coherent form. The chemical composition of the adhesive may be selected to be different, for example, depending on the materials which are intended to be connected. In this instance, the term “adhesive connection” refers to any connection in which a materially engaging connection is produced by a material which is referred to in this instance generally as an “adhesive”, as a shapeless mass (for example, liquid or paste-like) being brought into contact with the components which are intended to be connected and subsequently curing. In the cured state, the adhesive may preferably still be resilient in order, for example, to compensate for thermal expansion differences. The adhesive connection may preferably be produced directly with the body side component, but it could also be produced with an element which itself is connected to the body side component. The adhesive connection is used, on the one hand, for mechanical connection, on the other hand, it may also be used for sealing.

The body side component may have a trim element having a surface portion which forms an outer face of the motor vehicle, wherein the lock portion is formed by a lock element which is at least indirectly secured to the trim element. The trim element forms a portion of the outer trim of the motor vehicle. It may, for example, comprise sheet metal, plastics material or fiber composite material. The surface portion may be painted in known manner or otherwise coated in order to produce an appealing appearance. In any case, it forms an outer face which can be seen and touched from the outer side. In this embodiment, the roof rack sub-assembly has a lock element which forms the lock portion. For reasons of stability, the lock element may be produced from metal, for example, from sheet steel, but other materials are also conceivable. The lock element is produced separately from the trim element and subsequently connected to it. The connection may be produced in a releasable manner, for example, by use of screws, or also in a non-releasable manner, for example, by riveting, welding adhesive bonding or the like. The lock element may, for example, have at least one connection portion, which is connected directly or indirectly to the trim element, and the lock portion, wherein the mentioned portions are connected integrally to each other. Consequently, there may be formed between the lock portion and the body side component an intermediate space, in which the key portion is arranged in the introduction position. Under some circumstances, the trim element may not be sufficiently stable to support itself or to provide the corresponding portion of the body with adequate rigidity. The body side component may therefore have a structural element on which the trim element is supported. The corresponding structural element may, for example, be in the form of a shaped sheet metal component or be formed by a plurality of shaped sheet metal components which are welded to each other.

The surface portion may be separated from the roof element by a gap region in which the lock portion is at least partially arranged. The gap region may, for example, form a type of channel or groove between the surface portion and the roof element. In the gap region in any case a recess with respect to the adjacent surface portion and the roof element is formed. The gap region may, for example, serve to compensate for a different thermal expansion of the roof element and body side component. The gap region may be partially limited by the body side component, in particular by the trim element. In this instance, the profile of the trim element recedes with respect to the surface portion in the gap region. In this embodiment, the lock portion is at least partially arranged in the gap region, whereby it does not protrude or protrudes only slightly with respect to the surface portion and the roof element. This has both mechanical and visual advantages, particularly when in the meantime the support foot has been disassembled, while the lock portion (for example, as part of the lock element) remains on the motor vehicle. The gap region may be partially delimited by a recessed portion, which extends downward from the surface portion and horizontally in the direction of the roof element, of the trim element.

In a particular embodiment, the lock portion is arranged in a state recessed with respect to the surface portion and the roof element. This means that the lock portion is arranged both lower than the roof element and lower than the surface portion. These statements may also in particular relate to the above-mentioned lock element. In this context, “lower” may in particular relate to the vertical vehicle axis. Generally, however, this means that, when viewed from the outer side, the lock portion recedes both relative to the surface portion and relative to the roof element. It consequently does not protrude between the surface element and roof element and is under some circumstances not even visible from most viewing angles. Under some circumstances, as a result of this configuration, it may also be ensured that the roof element with a significant thermal expansion can expand in an unimpeded manner in the direction toward the surface portion without contacting with the lock portion.

According to one embodiment, the anchor element has a shaft portion which extends along the closure axis and which in the assembly state is received at least partially in a positive-locking manner in the support foot. The shaft portion is preferably configured integrally with the key portion. Embodiments are conceivable in which no clear distinction is possible between the shaft portion and key portion. The shaft portion may be configured in a linear manner. It may have an at least partially consistent cross section. For example, the closure axis may form an axis of symmetry of the shaft portion. In the assembly state, the shaft portion is at least partially received in the support foot in a positive-locking manner. For example, the support foot may have at least one through-opening through which the shaft portion is guided. The shaft portion and the support foot may in the assembly state be connected to each other directly and/or indirectly by an additional element.

One configuration makes provision for the key portion to have a central portion which is arranged around the closure axis, and at least one wing portion which protrudes radially from the central portion. The central portion may be configured in a rotationally symmetrical manner with respect to the closure axis, for example, in a circular cylindrical manner. It may adjoin the shaft portion or be formed by a part of the shaft portion. The at least one wing portion protrudes radially with respect to the central portion, wherein the term “radially” relates to the closure axis. In particular, a plurality of wing portions may be provided, for example, two. The lock opening is advantageously adapted to the cross section of the key portion so that it has an inner portion which corresponds to the central portion and for each wing portion an outer portion which protrudes radially with respect to the inner portion. Consequently, the key portion can be guided along the closure axis through the lock openings, wherein the central portion is guided through the inner portion and each wing portion is guided through an outer portion. If the anchor element is subsequently rotated, the tangential positions of the wing portion and outer portion no longer correspond to each other so that the anchor element cannot be pulled out again through the lock opening. Advantageously, the central portion and/or the inner portion are configured in a circular-cylindrical manner. In this instance, the inner diameter of the inner portion may be selected to be slightly larger than the outer diameter of the central portion. Accordingly, the inner dimensions of each outer portion may be selected to be slightly larger than the corresponding outer dimensions of the associated wing portion.

Advantageously, there is formed on the lock portion at least one tangentially limited stop portion which is configured, by a tangential positive-locking connection to the key portion, to limit the rotatability of the anchor element about the closure axis. The stop portion is tangentially limited, that is to say, it extends in a tangential direction not circumferentially about the closure axis, but instead only over a limited angle. If the anchor element is rotated, it comes into contact with the stop portion, whereby the rotational movement thereof is stopped. In particular, the stop portion may be configured to form the positive-locking connection mentioned with a wing portion of the anchor element. A plurality of stop portions may also be provided, for example, one for each wing portion. Depending on the position of the stop portion, the anchor element may be stopped in different positions. It could also be said that, as a result of the positive-locking connection, different rotation positions of the anchor element can be defined. For example, the at least one stop portion may define the introduction position. Consequently, a user when he/she wishes to remove the anchor element again receives haptic feedback when he/she has turned the anchor portion from the closure position back into the introduction position. Consequently, he/she can readily pull the anchor element out through the introduction opening again with the key portion. On the other hand, the at least one stop portion may also prevent the anchor element from being rotated too far beyond the closure position and potentially reaching the introduction position again. The at least one stop portion can advantageously be configured integrally with the lock portion, for example, as part of the lock element. In the case of a shaped sheet metal component, for example, by bending a part-region, on the one hand, a stop portion can be formed, and at the same time the gap which is produced may form an outer portion of the lock opening.

Via the support foot, some of the weight of the roof cross-beam and in particular a load which is resting thereon is transmitted to the body. Under some circumstances, the roof element may not be sufficiently stable to also absorb only a portion of the corresponding forces. Therefore, a support of the support foot on the body side component may be preferred. One embodiment makes provision for the support foot to be supported on the surface portion in the assembly state and to be spaced apart from the roof element. Optionally, the support foot can also be supported in the gap region. Preferably, it is supported exclusively on the surface portion. In any case, there is no force transmission to the roof element since the support foot is spaced apart from the roof element and consequently has no contact with it.

Although the anchor element, for example, with the above-mentioned shaft portion can form a positive-locking connection to the support foot, the corresponding positive-locking connection is normally only provided transversely with respect to the closure axis. In this instance, forces can be transmitted along the closure axis only via an additional element. According to a corresponding configuration, the roof rack sub-assembly has a clamping element which is configured in the assembly state to engage in a positive-locking manner with the anchor element and the support foot and to pretension the support foot with respect to the surface portion. The term “clamping element” relates to the function and is otherwise not intended to be interpreted to be limiting. The positive-locking connection of the clamping element, on the one hand, and the positive-locking connection of the key portion with the lock portion, on the other hand, on the whole enable the formation of the pretensioning. The pretensioning preferably acts in this instance along the closure axis. Since the starting point of the corresponding pretensioning may be offset laterally with respect to the surface portion, the pretensioning could lead to a torque. However, this can be absorbed via the roof cross-beam so that it does not lead to a twisting of the support foot.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A roof rack sub-assembly for a motor vehicle, the roof rack sub-assembly comprising:
a roof element;
a body side component having a lock portion having a lock opening;
a support foot for supporting a roof cross-beam which extends above the roof element in an assembly state of the roof rack sub-assembly; and
an anchor element for at least indirectly connecting the support foot to the body side component, wherein the anchor element is configured to be guided with a key portion through the lock opening along a closure axis into an introduction position and is further configured to be rotated out of the introduction position about the closure axis into a locking position in which the key portion engages with the lock portion in a direction of the closure axis in a positive-locking manner.

2. The roof rack sub-assembly according to claim 1, wherein the roof element is a glass roof element.

3. The roof rack sub-assembly according to claim 2, wherein the glass roof element is connected to the body side component by an adhesive connection.

4. The roof rack sub-assembly according to claim 3, wherein the body side component has a trim element having a surface portion which forms an outer face of the motor vehicle, and the lock portion is formed by a lock element which is at least indirectly secured to the trim element.

5. The roof rack sub-assembly according to claim 4, wherein the surface portion is separated from the roof element by a gap region in which the lock portion is at least partially arranged.

6. The roof rack sub-assembly according to claim 5, wherein the lock portion is arranged in a state recessed with respect to the surface portion and the roof element.

7. The roof rack sub-assembly according to claim 1, wherein the body side component is horizontally adjacent to the roof element.

8. The roof rack sub-assembly according to claim 1, wherein the roof element is connected to the body side component by an adhesive connection.

9. The roof rack sub-assembly according to claim 1, wherein the anchor element has a shaft portion which extends along the closure axis and which in the assembly state is received at least partially in a positive-locking manner in the support foot.

10. The roof rack sub-assembly according to claim 1, wherein the key portion has a central portion which is arranged around the closure axis and at least one wing portion which protrudes radially from the central portion.

11. The roof rack sub-assembly according to claim 9, wherein the lock portion has at least one tangentially limited stop portion which is configured, by a tangential positive-locking connection to the key portion, to limit the rotatability of the anchor element about the closure axis.

12. The roof rack sub-assembly according to claim 8, wherein the support foot is supported in the assembly state on the surface portion and is spaced apart from the roof element.

13. The roof rack sub-assembly according to claim 1, wherein a clamping element is configured in the assembly state to engage in a positive-locking manner with the anchor element and the support foot and to pretension the support foot with respect to the surface portion.

14. A roof rack sub-assembly for a motor vehicle, the roof rack sub-assembly comprising:
a glass roof element;
a body side component horizontally adjacent to the glass roof element and having a lock portion having a lock opening, wherein the body side component has a trim element having a surface portion which forms an outer face of the motor vehicle, and the lock portion is formed by a lock element which is at least indirectly secured to the trim element;
a support foot for supporting a roof cross-beam which extends above the roof element in an assembly state of the roof rack sub-assembly; and
an anchor element for at least indirectly connecting the support foot to the body side component, wherein the anchor element is configured to be guided with a key portion through the lock opening along a closure axis into an introduction position and is further configured to be rotated out of the introduction position about the closure axis into a locking position in which the key portion engages with the lock portion in a direction of the closure axis in a positive-locking manner.

15. The roof rack sub-assembly according to claim 14, wherein the surface portion is separated from the roof element by a gap region in which the lock portion is at least partially arranged.

16. The roof rack sub-assembly according to claim 15, wherein the lock portion is arranged in a state recessed with respect to the surface portion and the glass roof element.

17. The roof rack sub-assembly according to claim 14, wherein the glass roof element is connected to the body side component by an adhesive connection.

18. The roof rack sub-assembly according to claim 14, wherein the anchor element has a shaft portion which extends along the closure axis and which in the assembly state is received at least partially in a positive-locking manner in the support foot.

19. The roof rack sub-assembly according to claim 14, wherein the key portion has a central portion which is arranged around the closure axis and at least one wing portion which protrudes radially from the central portion, and wherein the lock portion has at least one tangentially limited stop portion which is configured, by a tangential positive-locking connection to the key portion, to limit the rotatability of the anchor element about the closure axis.

20. The roof rack sub-assembly according to claim 14, wherein a clamping element is configured in the assembly state to engage in a positive-locking manner with the anchor element and the support foot and to pretension the support foot with respect to the surface portion.
